(19) United States
(12) Patent Application Publication
(10) Pub. No.: US 2005/0187117 A1
(43) Pub. Date: Aug. 25, 2005

(54) Laundry detergent composition comprising an anionic detersive surfactant, sulphamic acid and/or water soluble salts thereof, and low levels of, or no, zeolite builders and phosphate builders

(76) Inventors: Nigel Patrick Somerville Roberts, Newcastle upon Tyne (GB); Alan Thomas Brooker, Newcastle upon Tyne (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/050,221

(22) Filed: Feb. 3, 2005

(30) Foreign Application Priority Data
Feb. 23, 2004 (EP) 04250966.1

(51) Int. Cl. C11D 1/00

(52) U.S. Cl. 510/108

(57) ABSTRACT

The present invention relates to a laundry detergent composition comprising (i) sulphamic acid and/or water-soluble thereof; and (ii) an anionic detersive surfactant; and (iii) from 0 wt % to 8 wt % zeolite builder; and (iv) from 0 wt % to 8 wt % phosphate builder.

### FIELD OF THE INVENTION

The present invention relates to laundry detergent compositions comprising sulphamic acid and/or water-soluble salts thereof.

### BACKGROUND

Laundry detergent compositions that comprise an anionic detersive surfactant need to ensure that the anionic detersive surfactant is capable of providing a fabric-cleaning benefit in both soft water washing conditions and hard water washing conditions. Anionic detersive surfactants such as linear alkyl benzene sulphonate are capable of complexing with free cations, including divalent cations such as calcium and/or magnesium cations, that are present in the wash liquor in such a manner as to cause the anionic detersive surfactant to precipitate out of solution, which leads to a reduction in the anionic detersive surfactant activity. In extreme cases, this can result in poor whiteness maintenance, poor particulate stain removal cleaning performance and poor fabric integrity benefits. This is especially problematic when the laundry detergent composition is used in hard-water washing conditions when there is a high concentration of free calcium cations.

The anionic detersive surfactant's tendency to complex with these free cations in the wash liquor in such a manner as to precipitate out of solution is mitigated by the presence of builders, such as zeolite builders and phosphate builders, which have a high binding constant with free cations such as calcium cations. These builders sequester free calcium and magnesium cations and reduce the formation of these undesirable complexes. However, zeolite builders are water-insoluble and their incorporation in laundry detergent compositions leads to poor dissolution of the laundry detergent composition, and can lead to undesirable residues being deposited on the fabric. In addition, detergent compositions that comprise high levels of zeolite builder form undesirable cloudy wash liquors upon contact with water. Whereas phosphate builders allegedly do not have favourable environmental profiles and their use in laundry detergent compositions is becoming less common; for example, due to phosphate legislation in many countries.

In view of the above problems, there remains a need for a laundry detergent composition comprising an anionic detersive surfactant, which has a good anionic detersive surfactant activity, a good environmental profile, and a good dissolution profile.

### SUMMARY OF THE INVENTION

The present invention overcomes the above problems by providing a laundry detergent composition comprising (i) sulphamic acid and/or water-soluble salts thereof; and (ii) an anionic detersive surfactant; and (iii) from 0 wt % to 8 wt % zeolite builder; and (iv) from 0 wt % to 8 wt % phosphate builder.

### DETAILED DESCRIPTION OF THE INVENTION

The laundry detergent composition is suitable for use in the laundering of fabrics. The detergent composition comprises sulphamic acid and/or water-soluble salts thereof. The water-soluble salt of sulphamic acid can be an alkali-metal or an alkaline-earth-metal salt of sulphamate. Other examples of water-soluble salts of sulphamic acid include ammonium sulphamate, zinc sulphamate and lead sulphamate. A preferred water-soluble salt of sulphamic acid is sodium sulphamate. Preferably, the detergent composition comprises sulphamic acid. The detergent composition preferably comprises (on a sulphamic acid basis) from 0.1 wt % to 20 wt % sulphamic acid, and/or water soluble salts thereof, however it may be preferred that the detergent composition comprises from 0.1 wt % to 15 wt %, or from 1 wt % to 12 wt %, or even from 3 wt % to 10 wt % sulphamic acid and/or water-soluble salts thereof. The sulphamic acid typically has the formula:
H₂NSO₃H
The sulphamic acid can be in zwitterionic form when present in the detergent composition; sulphamic acid in zwitterionic form has the formula:
H₃N⁺SO₃⁻
Possibly at least part of, possibly all of, the sulphamic acid is in zwitterionic form when present in the composition, for example as a separate particulate component.

The sulphamic acid can improve the dispensing and disintegration of the detergent composition. It is capable of reacting with a source of carbonate, if present, in an aqueous environment such as the wash liquor in the drum of an automatic washing machine or in the dispensing drawer of an automatic washing machine or some other dispensing device such as a ball (granulette) or a net, to produce carbon dioxide gas. The combination of sulphamic acid and a source of carbonate is an effervescence system that can improve the dispensing performance of the detergent composition. In addition, the extra agitation in the wash liquor provided by this effervescence system can also improve the cleaning performance of the detergent composition.

Sulphamic acid has a very low hygroscopicity, significantly lower than other acids such as citric acid, malic acid or succinic acid; sulphamic acid does not readily pick up water. Sulphamic acid is stable during storage of the detergent composition and does not readily degrade other components of the detergent composition under certain storage conditions such as high humidity. Surprisingly, the sulphamic acid is stable even in the presence of mobile liquid phases, for example non-ionic detersive surfactants. Even more surprisingly, the sulphamic acid does not readily degrade perfumes during storage under high humidity.

Preferably, the sulphamic acid, and/or water-soluble salts thereof, is in particulate form. When the detergent composition is in particulate form, especially a free-flowing particulate form, the sulphamic acid, and/or water-soluble salts thereof, is preferably in particulate form and preferably is incorporated into the detergent composition in the form of dry-added particles, preferably in the form of separate dry-added particles. The sulphamic acid may be in the form of a co-particulate admixture with a source of carbonate; this co-particulate admixture may be produced by methods such as agglomeration including pressure agglomeration, roller compaction, extrudation, spheronisation, or any combination thereof. Preferably, the sulphamic acid, and/or water-soluble salts thereof, in particulate form has a weight average particle size in the range of from 210 micrometers to 1,200 micrometers, or preferably from 250 micrometers to 800 micrometers. Preferably, the sulphamic acid, and/or water-soluble salts thereof, in particulate form has a particle size distribution such that no more than 35 wt % of the sulphamic acid, and/or water-soluble salts thereof, has a particle size of less than 250 micrometers, preferably no more than 30 wt % of the sulphamic acid, and/or water-soluble salts thereof, has a particle size of less than 250 micrometers, and preferably no more than 35 wt % of the sulphamic acid, and/or water-soluble salts thereof, has a particle size of greater than 1,000 micrometers, preferably no more than 25 wt % of the sulphamic acid, and/or water-soluble salts thereof, has a particle size of greater than 1,000 micrometers.

Sulphamic acid, and/or salts thereof, has a superior building capability than other acids such as citric acid, malic acid, succinic acid and salts thereof. Sulphamate, which is either incorporated in the composition or is formed in-situ in the wash liquor by the in-situ neutralisation of sulphamic acid, has a high binding efficiency with free cations (for example, such as calcium and/or magnesium cations to form calcium sulphamate and/or magnesium sulphamate, respectively). This superior building performance due to the presence of sulphamic acid and/or water-soluble salts thereof in the detergent composition is especially beneficial when the detergent composition comprises very low levels of, or no, zeolite builders and phosphate builders, when cleaning negatives associated with high levels of free calcium and/or magnesium cations in the wash liquor are most likely to occur.

One such cleaning negative associated with high levels of free calcium and/or magnesium cations in the wash liquor is poor whiteness maintenance. This is especially true when the detergent composition comprises high levels of carbonate.

It may be preferred for the detergent composition to comprise a carbonate salt, typically from 1 wt % to 50 wt %, or from 5 wt % to 25 wt % or from 10 wt % to 20 wt % carbonate salt. A preferred carbonate salt is sodium carbonate and/or sodium bicarbonate. A highly preferred carbonate salt is sodium carbonate. The carbonate salt, or at least part thereof, is typically in particulate form, typically having a weight average particle size in the range of from 200 to 500 micrometers. However, it may be preferred for the carbonate salt, or at least part thereof, to be in micronised particulate form, typically having a weight average particle size in the range of from 4 to 40 micrometers; this is especially preferred when the carbonate salt, or at least part thereof, is in the form of a co-particulate admixture with a non-ionic detersive surfactant.

High levels of carbonate improve the cleaning performance of the detergent composition, by increasing the pH of the wash liquor. This increased alkalinity improves the performance of the bleach, if present, increases the tendency of soils to hydrolyse which facilitates their removal from the fabric, and also increases the rate and degree of ionization of the soils to be cleaned; ionized soils are more soluble and easier to remove from the fabrics during the washing stage of the laundering process. In addition, high carbonate levels improve the flowability of the detergent composition when the detergent composition is in free-flowing particulate form.

However, carbonate anions readily complex with free calcium cations in the wash liquor to form calcium carbonate. Calcium carbonate is water-insoluble and can precipitate out of solution in the wash liquor, deposit on soil and fabric surfaces in the wash liquor and result in poor whiteness maintenance. Sulphamate diminishes the formation of calcium carbonate in the wash liquor by complexing with the free calcium cations in the wash liquor. In addition, sulphamic acid is capable of reacting with calcium carbonate to form calcium sulphamate, also liberating carbon dioxide and water; thus removing this calcium carbonate from the wash liquor and mitigating any negative effect on whiteness maintenance. The calcium sulphamate formed in-situ in the wash liquor is water-soluble and does not precipitate out of solution in the wash liquor.

The composition may comprise from 0 wt % to 10 wt % carbonate salt to minimize the negatives associated with the presence of carbonate salt in the composition. However, as described above in more detail, it may be desirable to incorporate higher levels of carbonate salt in the composition. If the composition comprises high levels of carbonate salt, such as at least 10 wt % carbonate salt, then the composition also preferably comprises an acid source that is capable of undergoing an acid/base reaction with a carbonate anion. The acid source can be sulphamic acid, citric acid, malic acid, succinic acid or any mixture thereof. An especially preferred acid source is sulphamic acid. Preferably, the weight ratio of carbonate salt to the total amount of acid source in the composition that is capable of undergoing an acid/base reaction with a carbonate anion, is preferably less than 50:1, more preferably less than 25:1, or less than 15:1, or less than 10:1 or even less than 5:1.

In order to minimise the undesirable effects of having too high a concentration of carbonate anions in the wash liquor, the total amount of carbonate anion source in the composition is preferably limited. Preferred carbonate anion sources are carbonate salts and/or percarbonate salts. Preferably, the total amount of carbonate anion source (on a carbonate anion basis) in the composition is between 7 wt % to 14 wt % greater than the theoretical amount of carbonate anion source that is required to completely neutralise the total amount of acid source present in the composition that is capable of undergoing an acid/base reaction with a carbonate anion. By controlling the total amount of carbonate anion source in the composition with respect to the amount of acid source in the composition, in the above described manner, all of the benefits of having of a carbonate anion source in the composition are maximised whilst all of the undesirable negative effects of having too high a concentration of carbonate anions in the wash liquor are minimised.

The detergent composition comprises an anionic detersive surfactant. The anionic surfactant can be selected from the group consisting of: C₁₀-C₁₈ alkyl benzene sulphonates (LAS), preferably linear C₁₀-C₁₃ alkyl benzene sulphonate; C₁₀-C₂₀ primary, branched-chain, linear-chain and random-chain alkyl sulphates (AS), preferred are linear alkyl sulphates, typically having the following formula:
CH₃(CH₂)ₓCH₂—OSO₃⁻M⁺,
wherein, M is hydrogen or a cation which provides charge neutrality, preferred cations include sodium and ammonium cations, wherein x is an integer of at least 7, preferably at least 9, highly preferred are linear or branched, substituted or unsubstituted C₁₂-C₁₈ alkyl sulphate; C₁₀-C₁₈ secondary (2,3) alkyl sulphates, typically having the following formulae: 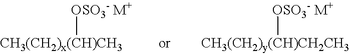
wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof. Preferred anionic detersive surfactants are: linear or branched, substituted or unsubstituted, C₁₂₋₁₈ alkyl sulphates; and linear or branched, substituted or unsubstituted, C₁₀₋₁₃ alkylbenzene sulphonates, preferably linear C₁₀₋₁₃ alkylbenzene sulphonates; and mixtures thereof.

It may be preferred for the anionic detersive surfactant to be structurally modified in such a manner as to cause the anionic detersive surfactant to be more calcium tolerant and less likely to precipitate out of the wash liquor in the presence of free calcium ions. This structural modification could be the introduction of a methyl or ethyl moiety in the vicinity of the anionic detersive surfactant's head group, as this can lead to a more calcium tolerant anionic detersive surfactant due to steric hindrance of the head group, which may reduce the anionic detersive surfactant's affinity for complexing with free calcium cations in such a manner as to cause precipitation out of solution. Other structural modifications include the introduction of functional moieties, such as an amine moiety, in the alkyl chain of the anionic detersive surfactant; this can lead to a more calcium tolerant anionic detersive surfactant because the presence of a functional group in the alkyl chain of an anionic detersive surfactant may minimise the undesirable physicochemical property of the anionic detersive surfactant to form a smooth crystal structure in the presence of free calcium ions in the wash liquor. This may reduce the tendency of the anionic detersive surfactant to precipitate out of solution.

The detergent composition may comprise other adjunct detersive surfactants in addition to the anionic detersive surfactant. The composition may comprise a non-ionic detersive surfactant, a cationic detersive surfactant, a zwitterionic detersive surfactant, an amphoteric detersive surfactant or a mixture thereof. The composition may comprise an adjunct detersive surfactant selected from the group consisting of: linear or branched, substituted or unsubstituted C₁₂₋₁₈ alkyl carboxylic acids; linear or branched, substituted or unsubstituted C₈₋₁₈ alkyl ethoxylated alcohols having an average degree of ethoxylation of from 1 to 10; linear or branched, substituted or unsubstituted C₁₂₋₂₄ alkyl N-methyl glucose amides; linear or branched, substituted or unsubstituted C₈₋₁₈ alkyl polyglucosides; amine oxides; linear or branched, substituted or unsubstituted C₁₂₋₂₄ alkyl betaines; linear or branched, mono-alkyl mono-hydroxyethyl di-methyl quaternary ammonium compounds; and mixtures thereof. Preferred quaternary ammonium cationic detersive surfactants have the formula:
(R)(R¹)(R²)(R³)N⁺X⁻
wherein, R is a linear or branched, substituted or unsubstituted C₆₋₁₈ alkyl or alkenyl moiety, R¹ and R² are independently selected from methyl or ethyl moieties, R³ is a hydroxyl, hydroxymethyl or a hydroxyethyl moiety, X is an anion which provides charge neutrality, preferred anions include halides (such as chloride), sulphate or sulphonate. Preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono C₁₀ alkyl mono-hydroxyethyl di-methyl quaternary ammonium chloride.

Typically, the detergent composition comprises more than one type of detersive surfactant in order to obtain a good cleaning performance across a broad spectrum of soil types and in a broad range of washing conditions. It may be preferred for the detergent composition to comprise a substantially hardness tolerant detersive surfactant system; this is especially preferred when the detergent composition comprises very low levels of, or no, zeolite builder and phosphate builder, or if the detergent composition is for use in hard water conditions. A preferred substantially hardness tolerant surfactant system is one that comprises anionic detersive surfactant, non-ionic detersive surfactant and optionally a cationic detersive surfactant. Preferably, the detergent composition comprises from 7 wt % to 15 wt %, preferably from 8 wt % to 12 wt % anionic detersive surfactant, from 2 wt % to 6 wt %, preferably from 2 wt % to 4 wt % non-ionic detersive surfactant and optionally from 0.5 wt % to 2 wt %, preferably from 1 wt % to 2 wt % cationic detersive surfactant. This surfactant system is especially preferred when the detergent composition comprises very low levels of, or no, zeolite builder and phosphate builder.

The detergent composition comprises from 0 wt % to 8 wt % zeolite builder. The detergent composition preferably comprises from 0 wt % to 6 wt %, or from 0 wt % to 4 wt %, or from 0 wt % to 2 wt % zeolite builder. It may even be preferred for the detergent composition to be substantially free from, or even completely free from, deliberately added zeolite builder. This is especially preferred if it is desirable for the detergent composition to be very highly soluble, to minimise the amount of water-insoluble residues (for example which may deposit on fabric surfaces), and also when it is highly desirable to have transparent wash liquor. Zeolite builders include zeolite A, zeolite X, zeolite P and zeolite MAP.

The detergent composition comprises from 0 wt % to 8 wt % phosphate builder. The detergent composition preferably comprises from 0 wt % to 6 wt %, or from 0 wt % to 4 wt %, or from 0 wt % to 2 wt % phosphate builder. It may even be preferred for the detergent composition to be substantially free from, or even completely free from, deliberately added phosphate builder. Phosphate builders include sodium tripolyphosphate.

The composition may comprise adjunct builders other than the zeolite builder and phosphate builder, especially preferred are water-soluble adjunct builders. Adjunct builders are preferably selected from the group consisting of sodium carbonate, sulphamic acid and/or water-soluble salts thereof, citric acid and/or water soluble salts thereof such as sodium citrate; polymeric polycarboxylates such as co-polymers of acrylic acid and maleic acid, or polyacrylate.

It may be preferred for the composition to comprise very low levels of water-insoluble builders such as zeolite A, zeolite X, zeolite P and zeolite MAP whilst comprising relatively high levels of water-soluble adjunct builders, such as sodium carbonate, sulphamic acid and citric acid.

It may be preferred for the weight ratio of sodium carbonate to zeolite builder to be at least 5:1, preferably at least 10:1, or at least 15:1, or at least 20:1 or even at least 25:1.

The detergent composition may comprise less than 10 wt %, or from 0 wt % to 5 wt %, or less than 4 wt %, or less than 2 wt % silicate salt. It may even be preferred for the detergent composition to be free from silicate salt. Silicate salts include water-insoluble silicates. Silicate salts include amorphous silicates and crystalline layered silicates (e.g. SKS-6). A preferred silicate salt is sodium silicate.

It may be preferred for the detergent composition to comprise at least 1 wt %, or at least 2 wt %, or at least 3 wt %, or at least 4 wt %, or even at least 5 wt % polymeric polycarboxylates. High levels of polymeric polycarboxylate can act as builders and sequester free calcium ions in the wash liquor, they can also act as soil dispersants and provide an improved particulate stain removal cleaning benefit. Preferred polymeric polycarboxylates include: polyacrylates, preferably having a weight average molecular weight of from 1,000 Da to 20,000 Da; co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da.

The detergent composition preferably comprises at least 10 wt % sulphate salt. High levels of sulphate salt can improve the greasy stain removal cleaning performance of the detergent composition. The detergent composition may preferably comprises very high levels of sulphate; the detergent composition typically comprises at least 15 wt % sulphate salt, or even at least 20 wt % sulphate salt, or even at least 25 wt % sulphate salt and sometimes even at least 30 wt % sulphate salt. A preferred sulphate salt is sodium sulphate.

The sodium sulphate and sulphamic acid are capable of complexing together in the presence of water to form a complex having the general formula:
6HSO₃NH₂.5Na₂SO₄.15H₂O
Such complexes are suitable for use herein.

The sulphate salt, or at least part thereof, is typically in particulate form, typically having a weight average particle size in the range of from 60 to 200 micrometers. However, it may be preferred that the sulphate salt, or at least part thereof, is in micronised particulate form, typically having a weight average particle size in the range of from 5 to less than 60 micrometers, preferably from 5 to 40 micrometers. It may even be preferred for the sulphate salt to be in coarse particulate form, typically having a weight average particle size of from above 200 to 800 micrometers.

The composition may preferably comprise less than 60 wt % total combined amount of carbonate and sulphate. The composition may comprise less than 55 wt %, or less than 50 wt %, or less than 45 wt %, or less than 40 wt % total combined amount of carbonate and sulphate.

The presence of potassium cations in the detergent composition is not desirable due to the negative effect the potassium cations have on the cleaning performance of the detergent composition. Therefore, the detergent composition preferably comprises less than 10 wt %, preferably less than 5 wt %, or even less than 2 wt %, or even less than 1 wt %, or even less than 0.2 wt %, or even less than 0.1 wt %, or even less than 0.05 wt %, or even less than 0.04 wt % potassium cations. Most preferably, the detergent composition is substantially free from, or even completely free from, deliberately added potassium cations.

It may also be preferred for the composition to comprise a soil dispersant having the formula:
bis((C₂H₅O)(C₂H₄O)n)(CH₃)—N⁺—CₓH₂ₓ—N⁺—(CH₃)-bis((C₂H₅O)(C₂H₄O)n)
wherein, n=from 20 to 30, and x=from 3 to 8. Other suitable soil dispersants are sulphonate or sulphated soil dispersants having the formula:
sulphonated or sulphated bis((C₂H₅O)(C₂H₄O)n)(CH₃)—N⁺—CₓH₂ₓ—N⁺—(CH₃)-bis((C₂H₅O)(C₂H₄O)n)
wherein, n=from 20 to 30, and x=from 3 to 8. Preferably, the composition comprises at least 1 wt %, or at least 2 wt %, or at least 3 wt % soil dispersants.

The detergent composition typically comprises adjunct components. These detergent adjunct components include: bleach such as percarbonate and/or perborate, preferably in combination with a bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; chelants such as diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid); enzymes such as amylases, carbohydrases, celluloses, laccases, lipases, oxidases, peroxidases, and proteases; suds suppressing systems such as silicone based suds suppressors; brighteners; photobleach; filler salts; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as polycarboxylates, alkoxylated polyamines and ethoxylated ethyleneimine polymers; and anti-redeposition components such as carboxymethyl cellulose and polyesters. Preferably, the detergent composition comprises less than 1 wt % chlorine bleach and less than 1 wt % bromine bleach. Preferably, the detergent composition is free from deliberately added bromine bleach and chlorine bleach.

The detergent composition can be in any form, for example the detergent composition can be in the form of a liquid. Alternatively, and preferably, the detergent composition is in the form of a solid; such as in form of free-flowing particles or in the form of a tablet. Preferably, the detergent composition is in the form of free-flowing particles such as agglomerates, extrudates, spray-dried particles, noodles, needles, flakes and combinations thereof. It may be preferred that the composition is not in tablet form. It may be preferred for the composition to be a granular laundry detergent composition. The detergent composition in free-flowing particulate form typically has a bulk density of from 450 g/l to 1,000 g/l, preferred low bulk density detergent compositions have a bulk density of from 550 g/l to 650 g/l and preferred high bulk density detergent compositions have a bulk density of from 750 g/l to 900 g/l. During the laundering process, the composition is typically contacted with water to give a wash liquor having a pH of from above 7 to 11, preferably from 8 to 10.5.

### EXAMPLES

### Example 1

Aqueous slurry composition.

| Component | % w/w Aqueous slurry |
|---|---|
| Ethylenediamine disuccinic acid | 0.35 |
| Brightener | 0.12 |
| Magnesium sulphate | 0.72 |
| Acrylate/maleate copolymer | 6.45 |
| Linear alkyl benzene sulphonate | 11.92 |
| Hydroxyethane di(methylene phosphonic acid) | 0.32 |
| Sodium carbonate | 4.32 |
| Sodium sulphate | 48.72 |
| Soap | 0.78 |
| Water | 25.89 |
| Miscellaneous | 0.41 |
| Total Parts | 100.00 |

Preparation of a Spray-Dried Powder.

An aqueous slurry having the composition as described above is prepared having a moisture content of 25.89%. The aqueous slurry is heated to 72° C. and pumped under high pressure (from 5.5×10⁶ Nm⁻² to 6.0×10⁶ Nm⁻²), into a counter current spray-drying tower with an air inlet temperature of from 270° C. to 300° C. The aqueous slurry is atomised and the atomised slurry is dried to produce a solid mixture is then cooled and sieved to remove oversize material (>1.8 mm) to form a spray-dried powder. Fine material (<0.15 mm) is elutriated with the exhaust air in the spray-drying tower and collected in a post tower containment system. The spray-dried powder has a moisture content of 1.0 wt %, a bulk density of 425 g/l and a particle size distribution such that 95.2% by weight of the spray-dried powder is between from 150 to 710 micrometers in size. The composition of the spray-dried powder is given below.

Spray-dried powder composition.

| | % w/w Spray |
|---|---|
| Component | dried powder |
| Ethylenediamine disuccinic acid | 0.47 |
| Brightener | 0.16 |
| Magnesium sulphate | 0.96 |
| Acrylate/maleate copolymer | 8.62 |
| Linear alkyl benzene sulphonate | 15.92 |
| Hydroxyethane di(methylene phosphonic acid) | 0.43 |
| Sodium carbonate | 5.77 |
| Sodium sulphate | 65.08 |
| Soap | 1.04 |
| Water | 1.00 |
| Miscellaneous | 0.55 |
| Total Parts | 100.00 |

Preparation of a Cationic Detersive Surfactant Particle.

The cationic surfactant particle is made on a 14.6 kg batch basis on a Morton FM-50 Loedige. 4.5 kg of micronised sodium sulphate and 4.5 kg micronised sodium carbonate is premixed in the mixer. 4.6 kg of 40% active mono-C₁₂₋₁₄ alkyl mono-hydroxyethyl di-methyl quaternary ammonium chloride (cationic surfactant) aqueous solution is added to the micronised sodium sulphate and micronised sodium carbonate in the mixer whilst both the main drive and the chopper are operating. After approximately two minutes of mixing, a 1.0 kg 1:1 weight ratio mix of micronised sodium sulphate and micronised sodium carbonate is added to the mixer as a dusting agent. The resulting agglomerate is collected and dried using a fluid bed dryer on a basis of 2500 l/min air at 100-140° C. for 30 minutes. The resulting powder is sieved and the fraction through 1400 μm is collected as the cationic surfactant particle. The composition of the cationic surfactant particle is as follows:
15% w/w mono-C₁₂₋₁₄ alkyl mono-hydroxyethyl di-methyl quaternary ammonium chloride
40.76% w/w sodium carbonate
40.76% w/w sodium sulphate
3.48% w/w moisture and miscellaneous
   Preparation of a Non-Ionic Detersive Surfactant Particle.

The non-ionic detersive surfactant particle is made on a 25 kg batch basis using a 1 m diameter cement mixer at 24 rpm. 18.9 kg light grade sodium sulphate supplied by Hamm Chemie under the tradename Rombach Leichtsulfat® is added to the mixer and then 6.1 kg C₁₄₋₁₅ ethoxylated alkyl alcohol having an average degree of ethoxylation of 7 (AE7) in liquid form is sprayed onto the sodium sulphate at 40° C. The mixture is mixed for 3 minutes to produce the non-ionic detersive surfactant particle, which is free flowing. The composition of the non-ionic detersive surfactant particle is as follows:
24.4% w/w C₁₄₋₁₅ ethoxylated alkyl alcohol having an average degree of ethoxylation of 7 (AE7)
75.6% w/w sodium sulphate
   Preparation of a Granular Laundry Detergent Composition in Accordance with the Present Invention.

10.15 kg of the spray-dried powder of example 1, 1.80 kg of the cationic detersive surfactant particle of example 1, 2.92 kg of the non-ionic detersive surfactant particle of example 1 and 10.13 kg (total amount) of other individually dosed dry-added material are dosed into a Im diameter concrete batch mixer operating at 24 rpm. Once all of the materials are dosed into the mixer, the mixture is mixed for 5 minutes to form a granular laundry detergent composition in accordance with the present invention. The formulation of the granular laundry detergent composition in accordance with the present invention is described below.

A granular laundry detergent composition in accordance with the
present invention.

| | % w/w |
|---|---|
| | granular |
| | laundry |
| | detergent |
| Component | composition |
| Spray-dried powder of example 1 | 40.61 |
| 91.6 wt % active linear alkyl benzene sulphonate flake | 2.96 |
| supplied by Stepan under the tradename Nacconol 90G ® | |
| Sulphamic acid (mixed grade) supplied by Rhodia | 7.50 |
| Sodium carbonate (coarse grade) | 7.90 |
| Sodium carbonate (micronised grade) | 1.87 |
| Sodium percarbonate (having from 12% to 15% active | 13.78 |
| AvOx) | |
| Photobleach particle | 0.01 |
| Enzymes | 0.67 |
| Tetraacetyl ethylene diamine agglomerate (92 wt % active) | 4.07 |
| Suds suppressor agglomerate (11.5 wt % active) | 0.41 |
| Acrylate/maleate copolymer particle (95.7 wt % active) | 0.27 |
| Green/blue carbonate speckle | 0.47 |
| Cationic detersive surfactant particle of example 1 | 7.18 |
| Non ionic detersive surfactant particle of example 1 | 11.67 |
| Solid perfume particle | 0.63 |
| Total Parts | 100.00 |

### Example 2

Aqueous slurry composition.

| Component | % w/w Aqueous slurry |
|---|---|
| Ethylenediamine disuccinic acid | 0.40 |
| Brightener | 0.13 |
| Magnesium sulphate | 0.83 |
| Acrylate/maleate copolymer | 7.42 |
| Cationic surfactant | 3.57 |
| Hydroxyethane di(methylene phosphonic acid) | 0.37 |
| Sodium sulphate | 44.67 |
| Sodium chloride | 10.63 |
| Soap | 0.90 |
| Water | 29.81 |
| Miscellaneous | 1.26 |
| Total Parts | 100.00 |

Preparation of a Spray-Dried Powder.

An aqueous slurry having the composition as described above is prepared having a moisture content of 29.81%. The aqueous slurry is heated to a temperature of from 65° C. to 80° C. and pumped under high pressure (from 5.5×10⁶ Nm⁻² to 6.0×10⁶ Nm⁻²), into a counter current spray-drying tower with an air inlet temperature of from 270° C. to 300° C. The aqueous slurry is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust air in the spray-drying tower and collected in a post tower containment system. The composition of the resultant spray-dried powder is described below.

Spray-dried powder composition

| | % w/w |
|---|---|
| Component | Spray-dried powder |
| Ethylenediamine disuccinic acid | 0.57 |
| Brightener | 0.19 |
| Magnesium sulphate | 1.17 |
| Acrylate/maleate copolymer | 10.47 |
| Cationic surfactant | 5.03 |
| Hydroxyethane di(methylene phosphonic acid) | 0.52 |
| Sodium sulphate | 63.00 |
| Sodium chloride | 15.00 |
| Soap | 1.27 |
| Water | 1.00 |
| Miscellaneous | 1.78 |
| Total Parts | 100.00 |

Preparation of a Non-Ionic Detersive Surfactant Particle

The non-ionic detersive surfactant particle is made on a 25 kg batch basis using a 1 m diameter cement mixer at 24 rpm. 18.9 kg light grade sodium sulphate supplied by Hamm Chemie under the tradename Rombach Leichtsulfat® is added to the mixer and then 6.1 kg C₁₄₋₁₅ ethoxylated alkyl alcohol having an average degree of ethoxylation of 7 (AE7) in liquid form is sprayed onto the sodium sulphate at 40° C. The mixture is mixed for 3 minutes to produce the non-ionic detersive surfactant particle, which is free flowing. The composition of the non-ionic detersive surfactant particle is as follows:
24.4% w/w C₁₄₋₁₅ ethoxylated alkyl alcohol having an average degree of ethoxylation of 7 (AE7)
75.6% w/w sodium sulphate
   Preparation of an Anionic Detersive Surfactant Particle.

The linear alkyl benzene sulphonate particle is made on a 14 kg batch basis on a Morton FM-50 Loedige. 7.84 kg micronised sodium sulphate and 2.70 kg micronised sodium carbonate are first added to the mixer while the main drive and chopper are operating. Then 3.46 kg linear alkyl benzene sulphonate paste (78 wt % active) is added to the mixer and mixed for 2 minutes to produce a mixture. The resulting mixture is collected and dried using a fluid bed dryer on a basis of 2500 l/min air at 100-140° C. for 30 minutes to produce the anionic detersive surfactant particle. The composition of the anionic detersive surfactant particle is as follows:
20% w/w linear alkyl benzene sulphonate
20% w/w sodium carbonate
58% w/w sodium sulphate
2% w/w miscellaneous and water
   Preparation of a Granular Laundry Detergent Composition in Accordance with the Present Invention.

10.15 kg of the spray-dried powder of example 2, 2.26 kg of the non-ionic detersive surfactant particle of example 2, 8.5 kg of the anionic detersive surfactant particle of example 2 and 4.09 kg (total) of other dry-added material are dosed into a 1 m diameter concrete batch mixer operating at 24 rpm. Once all of the materials are dosed into the mixer, the mixture is mixed for 5 minutes to form a granular laundry detergent composition in accordance with the present invention. The formulation of the granular laundry detergent composition in accordance with the present invention is described below.

A granular laundry detergent composition in accordance with the
present invention.

| | % w/w |
|---|---|
| | granular |
| | laundry |
| | detergent |
| Component | composition |
| Spray dried powder of example 2 | 40.61 |
| Sulphamic acid (granular grade) supplied by Rhodia | 2.50 |
| Percarbonate (having from 12% to 15% active AvOx) | 8.72 |
| Enzymes | 0.46 |
| TAED agglomerate (92% active) | 2.70 |
| Suds suppressor agglomerate (11.5% active) | 0.55 |
| Acrylate/maleate copolymer particle (95.7% active) | 0.89 |
| Anionic detersive surfactant particle of example 2 | 34.00 |
| Non-ionic detersive surfactant particle of example 2 | 9.05 |
| Solid perfume particle | 0.52 |
| Total | 100.00 |

### Example 3

Example 1 is repeated except that di-methyl mono-hydroxyethyl mono-C₁₀ quaternary ammonium chloride replaces the mono-C₁₂₋₁₄alkyl mono-hydroxyethyl di-methyl quaternary ammonium chloride in the cationic detersive surfactant agglomerate.

### Example 4

Example 1 is repeated except that 3.75%, by weight of the composition, of citric acid is dry-added, and the amount of dry-added sulphamic acid is reduced from 7.5% to 3.75% by weight of the composition.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A laundry detergent composition comprising:
(i) sulphamic acid and/or water-soluble salts thereof; and
(ii) an anionic detersive surfactant; and
(iii) from about 0 wt % to about 8 wt % zeolite builder; and
(iv) from about 0 wt % to about 8 wt % phosphate builder.

2. A composition according to claim 1, wherein the composition comprises from about 5 wt % to about 14 wt % anionic detersive surfactant, from about 2 wt % to about 8 wt % non-ionic detersive surfactant and optionally from about 0.5 wt % to about 3 wt % cationic detersive surfactant.

3. A composition according to claim 1, wherein the composition comprises from about 0 wt % to about 4 wt % zeolite builder.

4. A composition according to claim 1, wherein the composition comprises from about 0 wt % to about 4 wt % phosphate builder.

5. A composition according to claim 1, wherein the composition comprises from about 10 wt % to about 20 wt % carbonate salt.

6. A composition according to claim 1, wherein the composition comprises a carbonate salt and wherein if the composition comprises more than about 10 wt % carbonate salt, then the weight ratio of carbonate salt to sulphamic acid is less than about 5:1.

7. A composition according to claim 1, wherein the composition comprises from about 3 wt % to about 10 wt % sulphamic acid.

8. A composition according to claim 1, wherein the composition comprises at least about 3 wt % polymeric polycarboxylate.

9. A composition according to claim 1, wherein the composition comprises citric acid.

10. A composition according to claim 1, wherein the composition comprises from about 8 wt % to about 12 wt % anionic detersive surfactant, from about 2 wt % to about 6 wt % non-ionic detersive surfactant and optionally from about 1 wt % to about 2 wt % cationic detersive surfactant.

11. A composition according to claim 1, wherein the composition comprises less than about 4 wt % silicate salt.

12. A composition according to claim 1, wherein the sulphamic acid, and/or water-soluble salts thereof, is in particulate form having a weight average particle size in the range of from about 250 micrometers to about 800 micrometers.

13. A composition according to claim 1, wherein the sulphamic acid, and/or water-soluble salts thereof, is in particulate form having a particle size distribution such that no more than about 35 wt % sulphamic acid, and/or water-soluble salts thereof, has a particle size of less than about 250 micrometers and no more than about 35 wt % sulphamic acid, and/or water-soluble salts thereof, has a particle size of greater than about 1,000 micrometers.

14. A composition according to claim 1, wherein the anionic detersive surfactant is: linear C₁₀₋₁₃ alkyl benzene sulphonate; linear or branched, substituted or unsubstituted, C₁₂₋₁₈ alkyl sulphate; or mixtures thereof.

15. A composition according to claim 1, wherein the composition comprises a non-ionic detersive surfactant that is a C₈₋₁₈ alkyl ethoxylated alcohol having an average ethoxylation degree of from about 1 to about 10.

16. A composition according to claim 1, wherein the composition comprises a cationic detersive surfactant that is a mono-alkyl mono-hydroxyethyl di-methyl quaternary ammonium chloride.

17. A composition according to claim 1, wherein the composition comprises at least about 10 wt % sulphate salt.

18. A composition according to claim 1, wherein the composition comprises less than about 0.04 wt % potassium cations.

19. A composition according to claim 1, wherein the composition is in free-flowing particulate form.

20. A composition according to claim 1, wherein the composition comprises:
(i) a carbonate anion source; and
(ii) an acid source, which includes sulphamic acid, that is capable of undergoing an acid/base reaction with a carbonate anion,
wherein the total amount of carbonate anion source, on a carbonate anion basis, in the composition is between about 7 wt % to about 14 wt % greater than the theoretical amount of carbonate anion source that is required to completely neutralise the total amount of acid source present in the composition that is capable of undergoing an acid/base reaction with a carbonate anion.

21. A laundry detergent composition comprising sulphamic acid, wherein at least part of the sulphamic acid is in zwitterionic form.
